(19) United States
(12) Patent Application Publication
(10) Pub. No.: US 2007/0279405 A1
(43) Pub. Date: Dec. 6, 2007

(54) PLASMA DISPLAY AND DRIVING DEVICE THEREFOR

(76) Inventors: Pankaj Agarwal, Suwon-si (KR); Woo-Sup Kim, Seoul (KR); Su-Yong Chae, Gwacheon-si (KR); Bo-Hyung Cho, Seoul (KR)

Correspondence Address: CHRISTIE, PARKER & HALE, LLP, PO BOX 7068, PASADENA, CA, 91109-7068, US

(21) Appl. No.: 11/687,586

(22) Filed: Mar. 16, 2007

(30) Foreign Application Priority Data
Jun. 2, 2006 (KR) 10-2006-0050056

(51) Int. Cl. G09G 5/00

(52) U.S. Cl. 345/211

(57) ABSTRACT

A plasma display and a driving device therefor. In a sustain discharge driving circuit that includes a power recovery circuit and a sustain voltage supply circuit, a transformer is used. The transformer includes a primary coil and a secondary coil that are coupled with each other. The primary coil of the transformer is connected in parallel to a panel capacitor serving as a capacitive load so as to increase a change of a voltage that is applied to an inductor, such that a voltage rising period and a voltage falling period are reduced. With the reduction of the turn-on time of a switch, the power consumption of the switch is reduced. Further, as the inductor initially stores current, the occurrence of hard switching is reduced when a sustain discharge voltage is applied and elements of the circuit are protected.

### CROSS-REFERENCE TO RELATED APPLICATION

This application claims priority to and the benefit of Korean Patent Application No. 10-2006-0050056, filed in the Korean Intellectual Property Office on Jun. 2, 2006, the entire content of which is incorporated herein by reference.

### BACKGROUND OF THE INVENTION

1. Field of the Invention

The present invention relates to a plasma display and a driving device therefor.

2. Description of the Related Art

A plasma display is a flat panel display that displays text or images using plasma generated by gas discharge, and can have millions of discharge cells (hereinafter, simply referred to as “cells”) that are arranged in a matrix according to the size thereof.

In general, in the plasma display, one frame is divided into a plurality of subfields, each of which has a luminance weight value, and the plurality of subfields are driven. A gray level of a grayscale is expressed by a combination of the subfields. In general, each subfield includes a reset period, an address period, and a sustain period.

The reset period is a period during which the cells are initialized in order to stably perform an address discharge. The address period is a period during which cells to be turned on or not are selected from the plurality of cells. The sustain period is a period corresponding to the weight value of the corresponding subfield, during which a sustain discharge occurs in the cells selected during the address period.

The sustain discharge occurs when sustain pulses are alternately applied to two electrodes. Here, since the two electrodes serve as a capacitive load (hereinafter, also referred to as a “panel capacitor”), in order to apply the sustain pulses to the two electrodes, a charge and discharge power for the plasma display panel (PDP) of the plasma display, which is also known as a reactive power, is needed in addition to the power for the sustain discharge. Accordingly, a sustain discharge driving circuit generally includes a power recovery circuit that recovers and reuses the charge and discharge power for the PDP (or panel).

FIG. 1 is a view illustrating a type of a sustain discharge driving circuit according to the related art. As shown in FIG. 1, the sustain discharge driving circuit includes a sustain electrode driver 40 and a scan electrode driver 50.

The sustain electrode driver 40 includes a power recovery circuit 41 and a sustain voltage supply unit 42. The power recovery circuit 41 includes transistors Xr and Xf, an inductor L1, diodes D1 and D2, and a power recovery capacitor C1.

A first end of the inductor L1 is connected to sustain electrodes X of a panel capacitor (or panel) Cp, and a second end of the inductor L1 is connected to a cathode of the diode D1 and an anode of the diode D2. An anode of the diode D1 is connected to a source of the transistor Xr, and a drain of the transistor Xr is connected to the power recovery capacitor C1. A cathode of the diode D2 is connected to a drain of the transistor Xf and a source of the transistor Xf is connected to the power recovery capacitor C1. Here, a voltage Vs/2 that corresponds to about a half of the difference between a voltage Vs and a voltage 0V is charged in the power recovery capacitor C1. The power recovery circuit 41 having the above-described connection structure charges the panel capacitor Cp with the voltage Vs or discharges the panel capacitor Cp to the voltage 0V (or a ground voltage).

The sustain voltage supply unit 42 is connected to the sustain electrodes X and includes two transistors Xs and Xg. The transistor Xs is connected between a power supply that supplies the sustain discharge voltage Vs and the sustain electrodes X of the panel capacitor Cp. The transistor Xg is connected between a power supply that supplies the ground voltage and the panel capacitor Cp. The transistors Xs and Xg respectively supply the voltage Vs and the ground voltage to the panel capacitor Cp.

Like the sustain electrode driver 40, the scan electrode driver 50 includes a power recovery circuit 51 and a sustain voltage supply unit 52, whose structures and functions are substantially the same as those of the sustain electrode driver 40. Thus, a detailed description thereof will not be provided.

FIG. 2 is a view illustrating another type of a sustain discharge driving circuit according to the related art. As shown in FIG. 2, the sustain discharge driving circuit includes a sustain electrode driver 40′ and a scan electrode driver 50′. Here, the sustain electrode driver 40′ includes a power recovery circuit 41′ and a sustain voltage supply unit 42′, and the scan electrode driver 50′ includes only a sustain voltage supply unit 52′.

The sustain discharge driving circuit shown in FIG. 2 is substantially the same as that in FIG. 1, except for supplying and recovering the power by using a voltage that is applied to a panel capacitor (or panel) Cp without using a power recovery capacitor. Thus, a detailed description thereof will not be provided.

In the type of the sustain discharge driving circuit of FIG. 1, considering a parasitic resistance component of the panel, an on-off component of a switch element, and the like, the voltage that is applied between the first and second ends of the panel capacitor Cp is represented in Equation 1.

$${V}_{cp} ( t ) = ( \frac{{V}_{s}}{2} - {V}_{on} ) [ 1 - {e}^{- \frac{t}{τ}} ( cos ω t + \frac{R}{2 ω L} sin ω t ) ] , \\ τ = 2 L / R , \\ ω = \sqrt{1 / {LC}_{p} - {( R / 2 L )}^{2}} \qquad Equation 1$$

According to Equation 1, a value w corresponding to a resonance frequency is shown in the form of \sqrt{1/LCₚ}. In the case of the circuit of FIG. 1, since a resonance at half a period occurs, a voltage rising period or a voltage falling period is determined according to a value of the resonance frequency.

Also, with the development of the high image quality and large screen size panels, when an equivalent capacitance of the panels increases, an image can be stably displayed with a small inductance value when the panels are driven at high speed, because the time that is allocated to the sustain period is limited. However, when the sustain discharge driving circuits shown in FIGS. 1 and 2 are used, there is a limit to how far the voltage rising period can be reduced and/or the voltage falling period from the sustain period can be reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of the present invention reduces a voltage rising period and a voltage falling period from a sustain period for a plasma display and a driving device therefor.

A first embodiment of the present invention provides a plasma display that includes a plurality of first electrodes and a plurality of second electrodes corresponding to the plurality of first electrodes, wherein a panel capacitor formed by the plurality of first electrodes and the plurality of the second electrodes serves as a capacitive load. Here, the plasma display also includes: a first transistor having a first end connected to a first power source for supplying a first voltage and a second end connected to the first electrodes; a second transistor having a first end connected to the first electrodes and a second end connected to a second power source for supplying a second voltage lower in voltage level than the first voltage; a primary coil having a first end connected to the second end of the first transistor; a third transistor having a first end connected to a second end of the primary coil, the third transistor being for reducing a voltage applied between the first and second ends of the panel capacitor when turned on; a fourth transistor having a second end connected to the second end of the primary coil, the fourth transistor being for increasing the voltage applied between the first and second ends of the panel capacitor when turned on; a secondary coil having a first end connected to the first electrodes and coupled with the primary coil; an inductor having a first end connected to a second end of the secondary coil; a fifth transistor having a first end connected to a second end of the inductor, the fifth transistor being for reducing the voltage applied between the first and second ends of the panel capacitor when turned on; and a sixth transistor having a second end connected to the second end of the inductor, the sixth transistor being for increasing the voltage applied between the first and second ends of the panel capacitor when turned on.

A second embodiment of the present invention provides a driving device of a plasma display having a plurality of first electrodes and a plurality of second electrodes, wherein a panel capacitor formed by the plurality of first electrodes and the plurality of second electrodes serves as a capacitive load. Here, the driving device includes: a first transistor connected to the first electrodes, the first transistor being for applying a first voltage to the first electrodes when turned on; a second transistor connected to the first electrodes, the second transistor being for applying a second voltage lower in voltage level than the first voltage to the first electrodes when turned on; a third transistor connected to the second electrodes, the third transistor being for applying the first voltage to the second electrodes when turned on; a fourth transistor connected to the second electrodes, the fourth transistor being for applying the second voltage to the second electrodes when turned on; an inductor having a first end connected to the first electrodes; a fifth transistor having a first end connected to a second end of the inductor; a sixth transistor having a second end connected to the second end of the inductor; a seventh transistor having a second end connected to a second end of the fifth transistor; an eighth transistor having a first end connected to a first end of the sixth transistor; a primary coil connected between a contact of a first end of the seventh transistor and a second end of the eighth transistor, and the first transistor; and a secondary coil coupled with the primary coil and connected between the first electrodes and the first end of the inductor.

A third embodiment of the present invention provides a plasma display having a plurality of first electrodes, a plurality of second electrodes, a first electrode driver adapted to drive the first electrodes, and a second electrode driver adapted to drive the second electrodes, wherein a panel capacitor formed by the first electrodes and the second electrodes serves as a capacitive load. Here, the plasma display includes: a first inductor configured to be in resonance with the panel capacitor; and a second inductor coupled in parallel with the panel capacitor between the first electrode driver and the second electrode driver.

A fourth embodiment of the present invention provides a plasma display that includes: a panel including a plurality of first electrodes and a plurality of second electrodes; a first electrode driver adapted to drive the first electrodes; a second electrode driver adapted to drive the second electrodes; a first inductor coupled in parallel with the panel between the first electrode driver and the second electrode driver; and a second inductor coupled in series with the first inductor and the panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a type of a sustain discharge driving circuit according to the related art.

FIG. 2 is a view illustrating another type of a sustain discharge driving circuit according to the related art.

FIG. 3 is a view illustrating a plasma display according to an exemplary embodiment of the present invention.

FIG. 4 is a view illustrating a driving waveform of the plasma display according to the exemplary embodiment of the present invention.

FIG. 5 is a view illustrating a sustain discharge driving circuit according to a first exemplary embodiment of the present invention.

FIG. 6 is a view illustrating signal timing of the sustain discharge driving circuit in FIG. 5 so as to generate the driving waveform in FIG. 4.

FIGS. 7A, 7B, 7C, and 7D are simplified views illustrating an operation of the sustain discharge driving circuit in FIG. 5 according to the signal timing in FIG. 6.

FIG. 8 is a view of a sustain discharge driving circuit according to a second exemplary embodiment of the present invention.

FIG. 9 is a view illustrating signal timing of the sustain discharge driving circuit in FIG. 8 so as to generate the driving waveform in FIG. 4.

FIGS. 10A, 10B, 10C, and 10D are simplified views illustrating an operation of the sustain discharge driving circuit in FIG. 8 according to the signal timing in FIG. 9.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, when a portion is referred to as being “connected” to another portion, it can be directly connected to the another portion or be “electrically connected” to the another portion with one or more intervening portions interposed therebetween. Further, when a portion “includes” a constituent element, the portion may further include another constituent element, and may not exclude the another constituent element if there is no particular description otherwise.

Throughout the specification, the expression “a voltage is maintained” includes the following cases. Even though a potential difference between two predetermined points changes over time, the change falls within an acceptable range of the design criteria or a cause of the change is due to a parasitic component that is not considered by someone skilled in the art. Further, since a threshold voltage of a semiconductor device, such as a transistor, a diode, or the like, can be much lower than a discharge voltage, the threshold voltage is regarded as 0V and approximately represented.

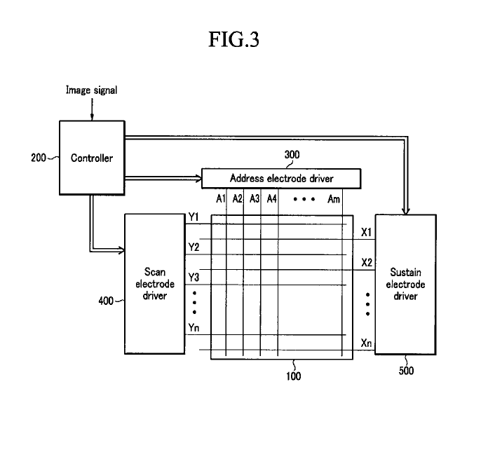

Initially, a plasma display according to an exemplary embodiment of the present invention will be described in more detail with reference to FIG. 3.

As shown in FIG. 3, the plasma display includes a plasma display panel (PDP) 100, a controller 200, an address driver 300, a scan electrode driver 400, and a sustain electrode driver 500. The PDP (or panel) 100 includes a plurality of address electrodes A1 to Am that extend in a column direction, and a plurality of sustain electrodes X1 to Xn and a plurality of scan electrodes Y1 to Yn that extend in a row direction. The plurality of scan electrodes Y1 to Yn and the plurality of sustain electrodes X1 to Xn are arranged in pairs. A discharge cell is formed by the scan electrodes and the sustain electrodes that are adjacent to each other, and the address electrodes that cross them.

The controller 200 receives an image signal from an external source and outputs an address driving control signal, a sustain electrode driving control signal, and a scan electrode driving control signal. The controller 200 divides one frame into a plurality of subfields and drives the plurality of subfields. Each of the subfields includes a reset period, an address period, and a sustain period with respect to temporal operating variations. The address driver 300 receives the address driving control signal from the controller 200 and applies a display data signal to each of the address electrodes A1 to Am so as to select a discharge cell to be displayed.

The scan electrode driver 400 receives the scan electrode driving control signal from the controller 200 and applies a driving voltage to each of the scan electrodes Y1 to Yn. The sustain electrode driver 500 receives the sustain electrode driving control signal from the controller 200 and applies a driving voltage to each of the sustain electrodes X1 to Xn.

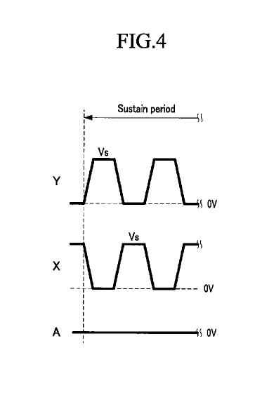

FIG. 4 is a view illustrating a driving waveform of the plasma display according to the exemplary embodiment of the present invention. FIG. 4 only shows a driving waveform during the sustain period.

As shown in FIG. 4, sustain pulses that alternately have a high level voltage (voltage Vs) and a low level voltage (voltage 0V) are applied in opposite phases to each other to the scan electrodes Y and the sustain electrodes X during the sustain period. The sustain pulses are repeatedly applied to the scan electrodes Y and the sustain electrodes X by the number of a weight value assigned to the corresponding subfield. That is, when the voltage Vs is applied to the scan electrodes Y, the voltage 0V is applied to the sustain electrodes X, and when the voltage Vs is applied to the sustain electrodes X, the voltage 0V is applied to the scan electrodes Y. In this way, individual voltage differences between the scan electrodes and the sustain electrodes of the panel capacitor (or panel) Cp alternately have a voltage Vs and a voltage −Vs. Accordingly, a sustain discharge can be repeated for a number of times in the discharge cell to turn on the discharge cell, wherein the number may be predetermined.

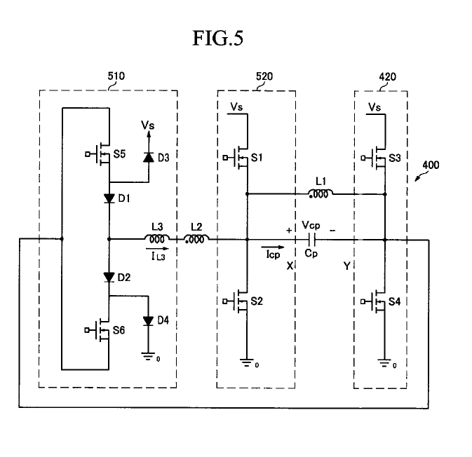

FIG. 5 is a view illustrating a sustain discharge driving circuit according to a first exemplary embodiment of the present invention.

As shown in FIG. 5, the sustain discharge driving circuit includes a scan electrode driver 400 and a sustain electrode driver 500.

The scan electrode driver 400 includes only a sustain voltage supply unit 420. The sustain electrode driver 500 includes a power recovery circuit 510 and a sustain voltage supply unit 520. Alternatively, in one embodiment, the sustain electrode driver 500 includes a power voltage supply, and the scan electrode driver 400 includes a power voltage supply and a power recovery circuit.

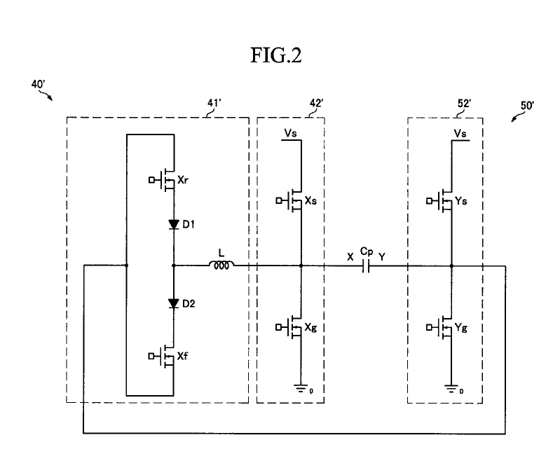

The sustain discharge driving circuit of FIG. 5 is substantially the same as that in FIG. 2, except for further including a primary coil (or inductor) L1 of a transformer that is connected in parallel to a panel capacitor (or panel) Cp and a secondary coil (or inductor) L2 of the transformer that is coupled with the primary coil L1 and connected in series with the panel capacitor Cp. Thus, a substantially duplicative description thereof will not be provided again.

As shown in FIG. 5, the primary coil L1 of the transformer is coupled such that it is connected in parallel with the panel capacitor Cp between the sustain voltage supply unit 420 of the scan electrode driver 400 and the sustain voltage supply unit 520 of the sustain electrode driver 500. That is, a second end of the primary coil L1 is connected to a source of a transistor S1, and a first end of the primary coil L1 is connected to a source of a transistor S3.

Further, the secondary coil L2 that is coupled with the primary coil L1 is connected between an inductor (or resonance inductor) L3 and the panel capacitor Cp.

Therefore, a voltage that is applied to the inductor L3 coupled with the secondary coil L2 is determined according to a turn ratio of coils wound around in the primary coil L1 and wound around in the secondary coil L2.

That is, when the turn ratio increases, a change rate of the voltage applied to the inductor L3 increases. Therefore, it is possible to reduce a period during which the voltage rises or falls (that is, a voltage rising period or a voltage falling period) when the power supply and the power recovery operation are performed.

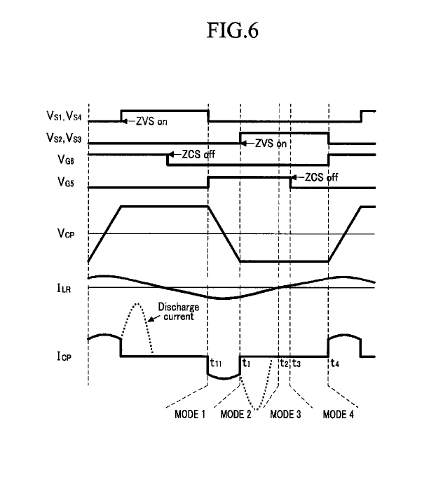

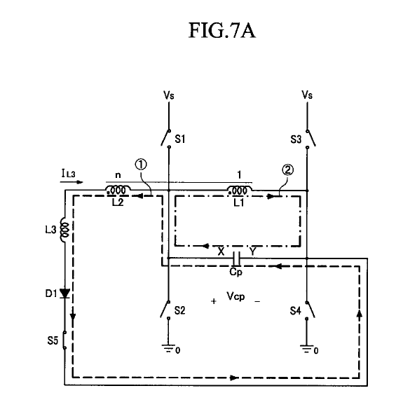

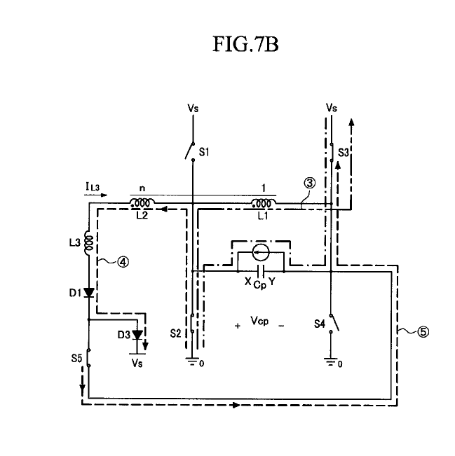

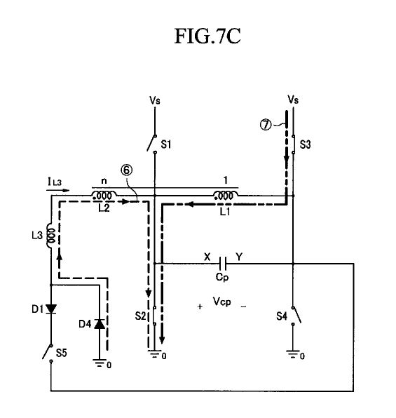

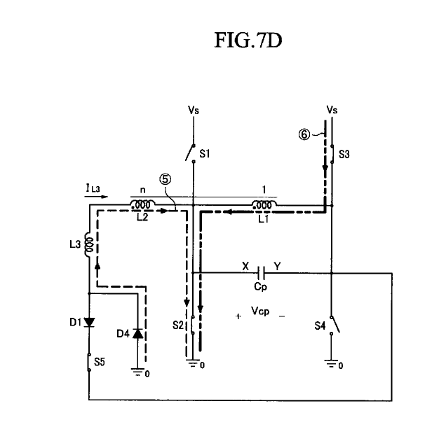

An operation of the sustain discharge driving circuit shown in FIG. 5 will be described in more detail with reference to FIG. 6, and FIGS. 7A to 7D.

FIG. 6 is a view illustrating signal timing of the sustain discharge driving circuit so as to generate the driving waveform in FIG. 4. FIGS. 7A to 7D are simplified views illustrating the operation of the sustain discharge driving circuit in FIG. 5 according to the signal timing in FIG. 6. First, assuming that transistors S1 and S4 are turned on before a mode 1 starts, and transistors S2, S3, S5, and S6 are turned off, a voltage Vcp that is applied between the first and second ends of the panel capacitor Cp is maintained at the voltage Vs. Further, it is assumed that a voltage of the X electrodes of the panel capacitor Cp is higher than a voltage of the Y electrodes thereof by the voltage Vcp. Further, for a current I_{L3} that flows through the inductor L3, it is assumed that a direction of the current I_{L3} that flows from the inductor L3 toward the secondary coil L2 is a positive (+) direction.

Referring to FIGS. 6 and 7A, in a mode 1 (t₀≦t≦t₁), the transistors S1 and S4 are turned off, and the transistor S5 is turned on. As shown in FIG. 7A, a resonance occurs in a path of the X electrodes of the panel capacitor Cp, the secondary coil L2, the inductor L3, the diode D1, the transistor S5, and the Y electrodes of the panel capacitor Cp (\textcircled{1}).

Further, a current path is formed by the X electrodes of the panel capacitor Cp, the primary coil L1, and the Y electrodes of the panel capacitor Cp (\textcircled{2}).

Next, in a mode 2 (t₁≦t≦t₂), the transistors S2 and S3 are turned on. As shown in FIG. 7B, a current path of the transistor S2, the primary coil L1, the transistor S3, and the power supply Vs is formed (\textcircled{3}). Then, a current path of the transistor S2, the secondary coil L2, the inductor L3, the diode D1, the diode D3, and the power supply Vs is formed (\textcircled{4}). In addition, a current path of the transistor S5, the transistor S3, and the power supply Vs is formed (\textcircled{5}), such that the voltage Vcp applied between the first and second ends of the panel capacitor Cp is maintained at a voltage −Vs.

Accordingly, the discharge current flows through the transistor S3, the panel capacitor Cp, and the transistor S2. Since the current flowing through the panel capacitor Cp is shown as a current source, the current flowing through the panel capacitor Cp is equivalently illustrated as a current source coupled in parallel with the panel capacitor Cp.

At this time, the size of the current I_{L3} flowing through the inductor L3 linearly decreases by the current paths (\textcircled{3}) and (\textcircled{4}).

Here, n denotes the number of turns of a secondary coil L2 when the number of turns of a primary coil L1 is equivalently set to be 1, as shown in FIG. 7A to FIG. 7D.

Further, the voltage that is applied to the inductor becomes a voltage (n+1)Vs as shown in Equation 2.

$${L}_{3} = \frac{d {i}_{L 3}}{d t} = ( n + 1 ) {V}_{S} \qquad Equation 2$$

Therefore, as shown in Equation 2, the higher the turn ratio 1:n of the coils that are wound around in the primary coil L1, and wound around in the secondary coil L2, is, the greater the voltage applied between the first and second ends of the inductor L3 is. Accordingly, the size of the current I_{L3} flowing through the inductor L3 reaches (or increases to) 0.

When the size of the current I_{L3} flowing through the inductor L3 becomes 0, in a mode 3 (t₂≦t≦t₃), as shown in FIG. 7C, a current path of the diode D4, the inductor L3, the secondary coil L2, and the transistor S2 is formed (\textcircled{6}). At the same time, a current path of the power supply Vs, the transistor S3, the primary coil L1, and the transistor S2 is formed (\textcircled{7}). At this time, as shown in FIGS. 6 and 7C, the size of the current I_{L3} of the inductor L3 is amplified by the primary coil L1 and secondary coil L2 that serve as the transformer, and linearly increases.

Then, in a mode 4 (t₃≦t≦t₄), the transistor S5 is turned off. As shown in FIGS. 6 and 7D, the size of current I_{L3} flowing through the inductor L3 linearly increases.

When the mode 4 finishes, the voltage of the panel capacitor Cp increases to the voltage Vs by the same methods of the modes 1 to 4, and then the voltage Vs is applied.

Further, when the primary coil L1 is connected in parallel to the panel capacitor Cp, a resonance frequency increases by (n+1) times. Therefore, it is possible for the voltage of the panel capacitor Cp to rise or fall at high speed.

Also, as shown in FIG. 6, since the current I_{L3} flowing through the inductor L3 continuously increases, the power consumption is increased and thus efficiency is reduced.

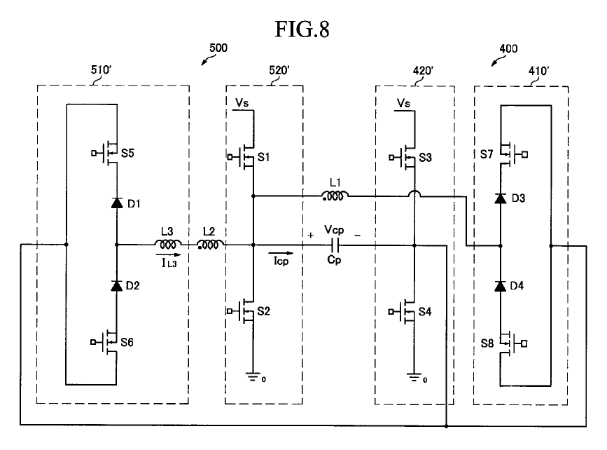

In order to address the above power consumption issue, a sustain discharge driving circuit according to a second exemplary embodiment of the present invention, as shown in FIG. 8, is provided.

FIG. 8 is a view of the sustain discharge driving circuit according to the second exemplary embodiment of the present invention.

As shown in FIG. 8, the sustain discharge driving circuit according to the second exemplary embodiment of the present invention includes a scan electrode driver 400′ and a sustain electrode driver 500′.

The scan electrode driver 400′ includes a power recovery circuit 410′ and a sustain voltage supply unit 420′. The sustain electrode driver 500′ also includes a power recovery circuit 510′ and a sustain voltage supply unit 520′.

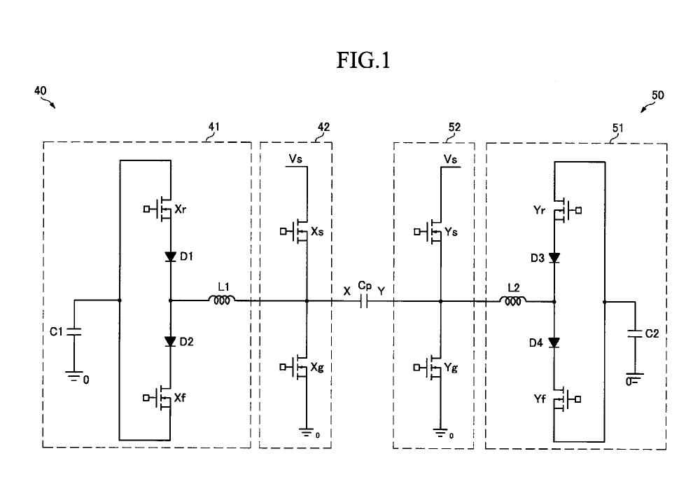

In FIG. 8, the sustain discharge driving circuit is substantially the same as that in FIG. 1, except for further including a primary coil (or inductor) L1 of a transformer that is connected in parallel to a panel capacitor (or panel) Cp and a secondary coil (or inductor) L2 of the transformer that is coupled with the primary coil L1 and connected in series with the panel capacitor Cp. Thus, a substantially duplicative description thereof will be omitted.

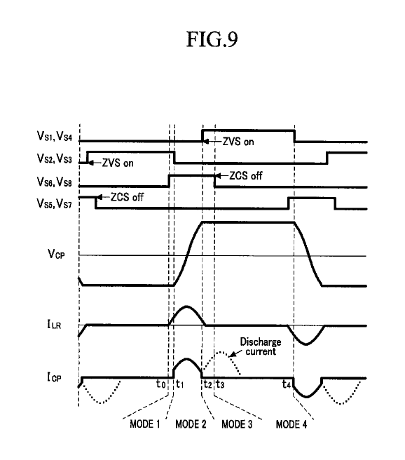

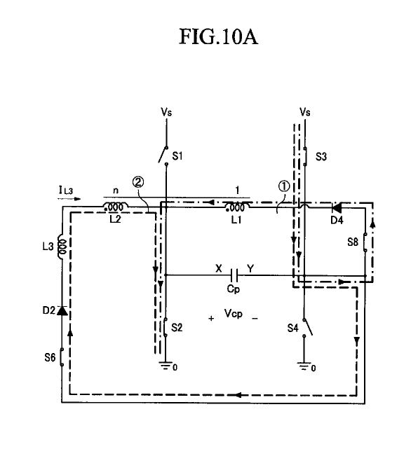

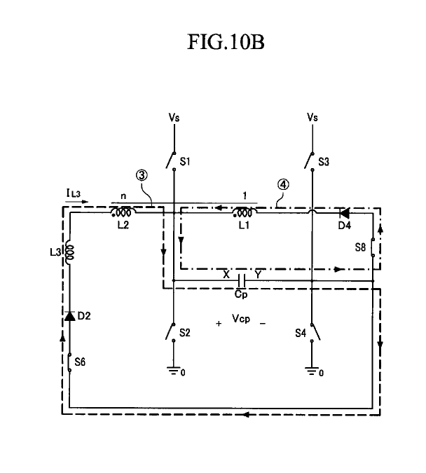

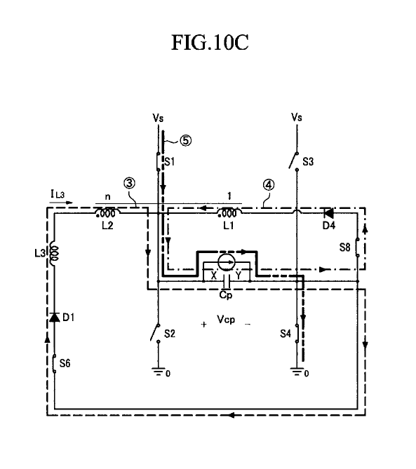

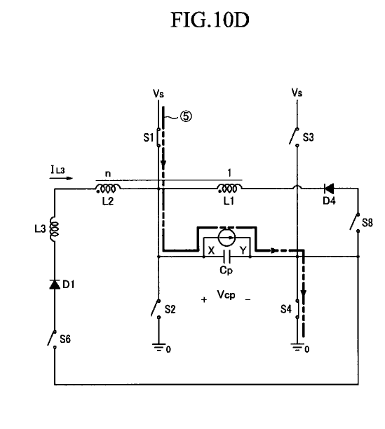

An operation of the sustain discharge driving circuit shown in FIG. 8 will be described in more detail with reference to FIGS. 9, and 10A to 10D.

FIG. 9 is a view illustrating signal timing of the sustain discharge driving circuit so as to generate the driving waveform in FIG. 4. FIGS. 10A to 10D are simplified views illustrating the operation of the sustain discharge driving circuit in FIG. 8 according to the signal timing in FIG. 9. First, assume that transistors S2 and S3 are turned on before a mode 1 M1 starts, and the remaining transistors S1, S4, S5, S6, S7, and S8 are turned off, the voltage Vcp that is applied between the first and second ends of the panel capacitor Cp is maintained at the voltage −Vs. Like the first embodiment, it is assumed that the voltage of the X electrodes of the panel capacitor Cp is higher than the voltage applied to the Y electrodes thereof by the voltage Vs.

Referring to FIGS. 9 and 10A, in a mode 1 (t₀≦t≦t₁), the transistors S6 and S8 are turned on. As shown in FIG. 10A, a path of the power supply Vs, the transistor S3, the transistor S8, the diode D4, the primary coil L1, the transistor S2, and the power supply 0V is formed (\textcircled{1}).

Further, a current path of the power supply Vs, the transistor S3, the transistor S6, the diode D2, the inductor L3, the secondary coil L2, the transistor S2, and the power supply 0V is formed (\textcircled{2}).

At this time, a current that is amplified by the primary coil L1 flows through the secondary coil L2, such that the amount of current stored in the inductor (or resonance inductor) L3 increases. Therefore, the current lo that is stored in the inductor L3 is represented in Equation 3.

$${I}_{O} = ( n + 1 ) \frac{{V}_{S} δ t}{{L}_{R}} , \\ δ t = {t}_{1} - {t}_{0} \qquad Equation 3$$

Therefore, as shown in FIG. 9, the current I_{L3} flowing through the inductor L3 is linearly increased by the current lo. The building up of the current I_{L3} in the mode 1 is for suppressing the occurrence of hard switching when the sustain voltage is applied by allowing the voltage (which is rising) to reach the voltage Vs, in consideration of the parasitic component that appears in the actual circuit, a voltage drop, and the like.

Next, the transistors S2 and S3 are turned off in a mode 2 (t₁≦t≦t₂). As shown in FIG. 10B, a resonance occurs in a path of the Y electrodes of the panel 6 capacitor Cp, the transistor S6, the diode D2, the inductor L3, the secondary coil L2, and the X electrodes of the panel capacitor Cp (\textcircled{3}). As the current stored in the inductor L3 is supplied to the panel capacitor Cp, the voltage Vcp applied between the first and second ends of the panel capacitor Cp increases from the voltage −Vs to the voltage Vs.

In addition, a path of the Y electrodes of the panel capacitor Cp, the transistor S8, the diode D4, the primary coil L1, and the X electrodes of the panel capacitor Cp is formed (\textcircled{4}).

At this time, according to the current path (\textcircled{3}), a circuit equation can be expressed as shown in Equation 4.

$${L}_{3} {C}_{p} \frac{{d}^{2} x}{d {t}^{2}} + {( n + 1 )}^{2} x = 0 \qquad Equation 4$$

Further, when an initial-value condition (I_{L3}=lo and Vcp=−Vs) is substituted into Equation 4, it is possible to obtain a value Vcp as shown in Equation 5.

$${v}_{CP} ( t ) = - {V}_{S} cos ( n + 1 ) {w}_{0} t + {I}_{0} \sqrt{\frac{{L}_{3}}{{C}_{P}}} sin ( n + 1 ) {w}_{0} t , \\ {ω}_{0} = \frac{1}{\sqrt{{L}_{3} {C}_{p}}} \qquad Equation 5$$

As shown in Equation 5, since a frequency of the voltage Vcp becomes (n+1)ω₀, the frequency increases (n+1) times more than the resonance frequency as shown in Equation 1, such that a resonance period is reduced. Accordingly, the second exemplary embodiment of the present invention can dramatically reduce the rising period or the falling period of the voltage of the panel capacitor Cp.

Then, in a mode 3 (t₂≦t≦t₃), the transistors S1 and S4 are turned on. As shown in FIG. 10C, a current path of the power supply Vs, the transistor S1, the panel capacitor Cp, the transistor S4, and the power supply 0V is formed (\textcircled{5}), such that the voltage Vcp applied between the first and second ends of the panel capacitor Cp is maintained at the voltage Vs.

Also, the size of the current I_{L3} flowing through the inductor L3 is linearly reduced as shown in Equation 6.

$${L}_{3} \frac{d {i}_{L 3}}{d t} = - ( n + 1 ) {V}_{S} \qquad Equation 6$$

When the size of the current I_{L3} flowing through the inductor L3 becomes 0, as shown in FIG. 10D, in a mode 4 (t₃≦t≦t4), the transistors S6 and S8 are turned off and thus only a current path (\textcircled{5}) is formed. Here, discharge current flows through the transistor S1, the panel capacitor Cp, the transistor S4 and ground.

Therefore, in the mode 4, the current does not flow through the inductor L3. That is, unlike the first exemplary embodiment of the present invention, according to the second exemplary embodiment of the present invention, the current only flows through the inductor L3 during the rising period or the falling period of the voltage of the panel capacitor Cp, and the current does not flow through the inductor L3 when the voltage Vs is applied.

Therefore, unlike the first exemplary embodiment of the present invention, the current does not flow through the inductor L3 when the voltage Vs or the voltage −Vs is applied, thereby reducing power consumption.

Further, when the mode 4 finishes in the second exemplary embodiment of the present invention, the voltage of the panel capacitor Cp increases to the voltage −Vs according to substantially the same methods as that of the modes 1 to 4, and the voltage −Vs is applied.

As described above, according to certain embodiments of the present invention, a sustain discharge driving circuit includes a primary coil of a transformer that is connected in parallel to a panel capacitor serving as a capacitive load such that the rising period and the falling period of the voltage applied between the first and second ends of the panel capacitor are reduced. As a result, the time, during which the switch is turned on, is reduced, and the power consumption is reduced. Further, when the sustain voltage is alternately applied, the current is initially applied to the inductor and energy stored in the inductor is used, such that the occurrence of hard switching when the sustain voltage is applied is reduced to thereby protect elements of the circuit, and the power consumption during the sustain discharge can be further reduced.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A plasma display having a plurality of first electrodes and a plurality of second electrodes corresponding to the plurality of first electrodes, wherein a panel capacitor formed by the plurality of first electrodes and the plurality of the second electrodes serves as a capacitive load, the plasma display comprising:
a first transistor having a first end connected to a first power source for supplying a first voltage and a second end connected to the first electrodes;
a second transistor having a first end connected to the first electrodes and a second end connected to a second power source for supplying a second voltage lower in voltage level than the first voltage;
a primary coil having a first end connected to the second end of the first transistor;
a third transistor having a first end connected to a second end of the primary coil, the third transistor being for reducing a voltage applied between the first and second ends of the panel capacitor when turned on;
a fourth transistor having a second end connected to the second end of the primary coil, the fourth transistor being for increasing the voltage applied between the first and second ends of the panel capacitor when turned on;
a secondary coil having a first end connected to the first electrodes and coupled with the primary coil;
an inductor having a first end connected to a second end of the secondary coil;
a fifth transistor having a first end connected to a second end of the inductor, the fifth transistor being for reducing the voltage applied between the first and second ends of the panel capacitor when turned on; and
a sixth transistor having a second end connected to the second end of the inductor, the sixth transistor being for increasing the voltage applied between the first and second ends of the panel capacitor when turned on.

2. The plasma display of claim 1, wherein a contact of a second end of the third transistor and a first end of the fourth transistor is electrically connected to a contact of a second end of the fifth transistor and a first end of the sixth transistor.

3. The plasma display of claim 2, further comprising:
a seventh transistor having a first end connected to the first power supply and a second end connected to the second electrodes; and
an eighth transistor having a first end connected to the second electrodes and a second end connected to the second power supply.

4. The plasma display of claim 3, further comprising:
a first diode having a cathode connected to the first end of the fifth transistor and an anode connected to the second end of the inductor;
a second diode having a cathode connected to the second end of the inductor and an anode connected to the second end of the sixth transistor;
a third diode having a cathode connected to the first end of the third transistor and an anode connected to the second end of the primary coil; and
a fourth diode having a cathode connected to the second end of the first coil and an anode connected to the second end of the fourth transistor.

5. The plasma display of claim 4, wherein the primary coil is connected in parallel to the panel capacitor.

6. The plasma display of claim 4, wherein:
the second and seventh transistors are turned on such that the voltage applied between the first and second ends of the panel capacitor becomes a third voltage lower in voltage level than the second voltage;
the fourth and sixth transistors are turned on such that the voltage applied between the first and second ends of the panel capacitor gradually increases;
the first and eighth transistors are turned on such that the voltage applied between the first and second ends of the panel capacitor becomes the first voltage; and
the third and fifth transistors are turned on such that the voltage applied between the first and second ends of the panel capacitor gradually decreases.

7. The plasma display of claim 6, wherein the first voltage is a sustain discharge voltage.

8. The plasma display of claim 6, wherein the second voltage is a ground voltage.

9. The plasma display of claim 6, wherein the third voltage has the same magnitude as the first voltage and a phase different from the first voltage.

10. A device for driving a plasma display having a plurality of first electrodes and a plurality of second electrodes, wherein a panel capacitor formed by the plurality of first electrodes and the plurality of second electrodes serves as a capacitive load, the device comprising:
a first transistor connected to the first electrodes, the first transistor being for applying a first voltage to the first electrodes when turned on;
a second transistor connected to the first electrodes, the second transistor being for applying a second voltage lower in voltage level than the first voltage to the first electrodes when turned on;
a third transistor connected to the second electrodes, the third transistor being for applying the first voltage to the second electrodes when turned on;
a fourth transistor connected to the second electrodes, the fourth transistor being for applying the second voltage to the second electrodes when turned on;
an inductor having a first end connected to the first electrodes;
a fifth transistor having a first end connected to a second end of the inductor;
a sixth transistor having a second end connected to the second end of the inductor;
a seventh transistor having a second end connected to a second end of the fifth transistor;
an eighth transistor having a first end connected to a first end of the sixth transistor;
a primary coil connected between a contact of a first end of the seventh transistor and a second end of the eighth transistor, and the first transistor; and
a secondary coil coupled with the primary coil and connected between the first electrodes and the first end of the inductor.

11. The device of claim 10, wherein the first transistor comprises a first end connected to a first power source for supplying the first voltage and a second end, and wherein the primary coil is connected between the contact of the first end of the seventh transistor and the second end of the eighth transistor, and the second end of the first transistor.

12. The device of claim 10, further comprising:
a first diode having a cathode connected to the first end of the fifth transistor and an anode connected to the second end of the inductor;
a second diode having a cathode connected to the second end of the inductor and an anode connected to the second end of sixth transistor;
a third diode having a cathode connected to the first end of the seventh transistor and an anode connected to the primary coil; and
a fourth diode having a cathode connected to the primary coil and an anode connected to the second end of the eighth transistor.

13. The device of claim 10, wherein the primary coil is connected in parallel to the panel capacitor.

14. The device of claim 13, wherein:
the second and third transistors are turned on such that the second voltage is applied to the first electrodes and the first voltage is applied to the second electrodes;
the sixth and eighth transistors are turned on such that a voltage of the first electrodes gradually increases to the first voltage and a voltage of the second electrodes gradually decreases to the second voltage;
the first and fourth transistors are turned on such that the first voltage is applied to the first electrodes and the second voltage is applied to the second electrodes; and
the fifth and seventh transistors are turned on such that the voltage of the first electrodes gradually decreases to the second voltage, and the voltage of the second electrodes gradually increases to the first voltage.

15. The device of claim 14, wherein the first voltage is a sustain discharge voltage.

16. The device of claim 14, wherein the second voltage is a ground voltage.

17. A plasma display having a plurality of first electrodes, a plurality of second electrodes, a first electrode driver adapted to drive the first electrodes, and a second electrode driver adapted to drive the second electrodes, wherein a panel capacitor formed by the first electrodes and the second electrodes serves as a capacitive load, the plasma display comprising:
a first inductor configured to be in resonance with the panel capacitor; and
a second inductor coupled in parallel with the panel capacitor between the first electrode driver and the second electrode driver.

18. The plasma display of claim 17, wherein at least a portion of the first inductor and the second inductor are configured to operate as a transformer.

19. The plasma display of claim 17, wherein the first inductor comprises a resonance inductor and a first coil of a transformer, and wherein the second inductor comprises a second coil of the transformer.

20. The plasma display of claim 19, wherein the first coil of the transformer is coupled with the second coil of the transformer and between the resonance inductor and the panel capacitor, and wherein the second coil of the transformer is coupled in parallel with the panel capacitor between the first electrode driver and the second electrode driver.

21. The plasma display of claim 17, wherein a first number of coils are wound in at least a portion of the first inductor, wherein a second number of coils are wound in the second inductor, and wherein the first number is greater than the second number.

22. A plasma display comprising:
a panel comprising a plurality of first electrodes and a plurality of second electrodes;
a first electrode driver adapted to drive the first electrodes;
a second electrode driver adapted to drive the second electrodes;
a first inductor coupled in parallel with the panel between the first electrode driver and the second electrode driver; and
a second inductor coupled in series with the first inductor and the panel.

23. The plasma display of claim 22, wherein the first inductor and at least a portion of the second inductor are configured to operate as a transformer.

24. The plasma display of claim 22, wherein the first inductor comprises a first coil of a transformer, and wherein the second inductor comprises a resonance inductor and a second coil of the transformer.

25. The plasma display of claim 24, wherein the second coil of the transformer is coupled with the first coil of the transformer and between the resonance inductor and the panel, and wherein the first coil of the transformer is coupled in parallel with the panel between the first driver and the second driver.

26. The plasma display of claim 22, wherein a first number of coils are wound in at least a portion of the first inductor, wherein a second number of coils are wound in the second inductor, and wherein the first number is lower than the second number.
